(19) United States
(12) Patent Application Publication
(10) Pub. No.: US 2024/0217034 A1
(43) Pub. Date: Jul. 4, 2024

(54) METHODS AND SYSTEMS FOR BIPOLAR PLATE ACTIVATION

(71) Applicant: ESS TECH, INC., Wilsonville, OR (US)

(72) Inventors: Nathan Imholt, Beaverton, OR (US); Brady Thompson, Canby, OR (US)

(21) Appl. No.: 18/395,202

(22) Filed: Dec. 22, 2023

Related U.S. Application Data
(60) Provisional application No. 63/477,666, filed on Dec. 29, 2022.

(51) Int. Cl. B23K 26/362; B23K 26/352; B23K 26/60; B23K 26/70; H01M 8/026; H01M 8/18

(52) U.S. Cl. CPC B23K 26/362; B23K 26/3584; B23K 26/60; B23K 26/703; H01M 8/026; H01M 8/188

(57) ABSTRACT

Systems and methods are provided for surface pretreatment of a bipolar plate for a battery system. In one example, a method for pretreating the bipolar plate includes extruding a material of the bipolar plate and irradiating a surface of the bipolar plate with a laser beam to etch a pattern into the surface. The method may further includes assembling the bipolar plate into a power module of the battery system.

### CROSS-REFERENCE TO RELATED APPLICATIONS

The present application claims priority to U.S. Provisional Application No. 63/477,666 entitled METHODS AND SYSTEMS FOR BIPOLAR PLATE ACTIVATION filed Dec. 29, 2022. The entire contents of the above identified application are hereby incorporated by reference for all purposes.

### FIELD

The present description relates generally to systems and methods for activating surfaces of bipolar plates for use in battery systems.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive, due to incorporation of low-cost, earth-abundant materials. In general, iron redox flow batteries (IFBs) rely on iron, salt, and water for electrolyte, thus including simple, earth-abundant, and inexpensive materials, and eliminating incorporation of harsh chemicals and reducing an environmental footprint thereof.

The IFB may include a positive (redox) electrode where a redox reaction occurs and a negative (plating) electrode where ferrous iron (Fe²⁺) in the electrolyte may be reduced and plated. Various side reactions may compete with the Fe²⁺ reduction, including proton reduction, iron corrosion, and iron plating oxidation:

$$\begin{matrix}{H}^{+} + {e}^{-} ↔ 1 / 2 {H}_{2} & ( proton reduction )\end{matrix} \qquad ( 1 )$$

$$\begin{matrix}{Fe}^{0} + 2 {H}^{+} ↔ {Fe}^{2} + {H}_{2} & ( iron corrosion )\end{matrix} \qquad ( 2 )$$

$$\begin{matrix}2 {Fe}^{3 +} + {Fe}^{0} ↔ 3 {Fe}^{2 +} & ( iron plating oxidation )\end{matrix} \qquad ( 3 )$$

As most side reactions occur at the plating electrode, IFB cycling capabilities may be limited by available iron plating on the plating electrode.

In some examples, the redox and plating electrodes may be in physical or fluid contact with respective bipolar plates. The bipolar plates may be highly conductive, such that the electrolyte may be transported to reaction sites of the redox and plating electrodes, and may further serve as fluid separators for electrolyte flow and distribution. In one example, a bipolar plate installed for use with the plating electrode may be formed from a carbon and/or graphite composite. Preparation of the carbon/graphite composite based bipolar plate may include compression or injection molding of a carbon/graphite composite starting material. In some examples, such molding processes may generate a resin-rich outer layer on one or more surfaces of the bipolar plates. However, bipolar plates formed in this way may be ill-suited for IFB inclusion, as the resin-rich outer layer may induce relatively high resistance, poor conductivity and result in poor plating quality in which metal plated onto the bipolar plates may be nonhomogeneous, non-uniform, and prone to flaking.

Accordingly, pretreatment of molded graphite composite based bipolar plates may be employed to mitigate poor electrochemical performance therefrom during IFB operation. For example, the bipolar plates may be mechanically pretreated via grinding, polishing, sand blasting, sand paper polishing, a timing belt, and/or other manual or automated mechanical pretreatments that scrape or scratch the bipolar plates. However, such mechanical pretreatments may generate inconsistent roughening of surfaces of the bipolar plates, brought on by uneven pressures and application times of manufacturing equipment used. Further, the mechanical surface treatment may rely on consumables, such as belts, which may increase manufacturing costs. Roughening provided by various manufacturing components or setups may result in increased random error distribution of surface structures on individual bipolar plates or between separately manufactured bipolar plates.

In one example, the issues described above may be addressed by a method for pretreatment of a bipolar plate for a battery system, the method including extruding a material of the bipolar plate and irradiating a surface of the bipolar plate with a laser beam to etch a pattern into the surface. The method further includes assembling the bipolar plate into a power module of the battery system. In this way, at least one surface of the bipolar plate may be activated, such that long-term durability and a performance of the battery system may be increased in a reproducible and consistent manner.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a battery cell with redox and plating electrodes, bipolar plates, and a membrane separator.

FIG. 2 shows an exploded of an example of a bipolar plate assembly, which may include one or more pretreated bipolar plates.

FIG. 3 shows an example of a laser ablation system for providing surface pretreatment of bipolar plates.

FIG. 4 shows an example of a conventional process flow for manufacturing a pretreated bipolar plate for a battery module.

FIG. 5A shows a first example of a process flow for manufacturing a pretreated bipolar plate for a battery module, where laser ablation is used to treat the bipolar plate surface.

FIG. 5B shows a second example of a process flow for manufacturing a pretreated bipolar plate for a battery module, where laser ablation is used to treat the bipolar plate surface.

FIG. 6 shows an angled view of a bipolar plate with a surface treated by laser ablation.

FIG. 7 shows a top-down view of the bipolar plate of FIG. 6.

FIG. 8 shows a roughness profile of the bipolar plate of FIG. 6.

FIG. 9 shows an example of a bipolar plate with a surface treated by laser ablation.

FIG. 10 shows an example of a bipolar plate with a surface treated by a mechanical technique.

FIG. 11 shows a graph plotting laser ablation cycle time relative to laser power.

### DETAILED DESCRIPTION

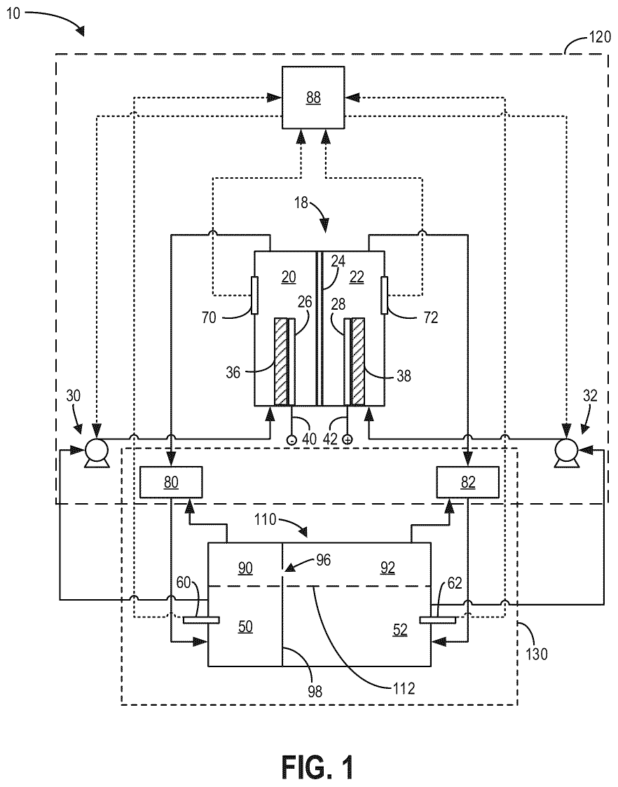

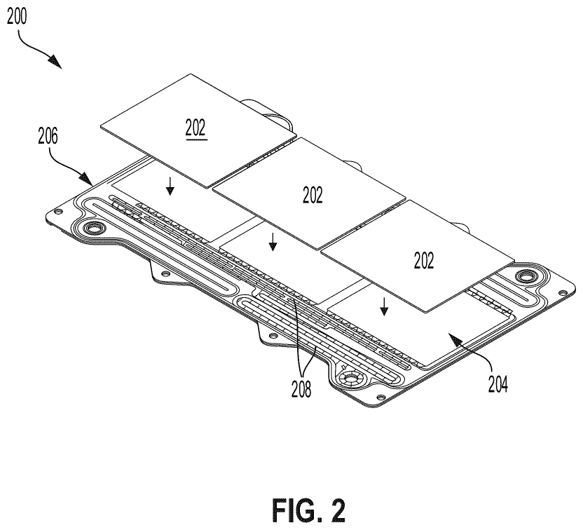

The following description relates to systems and methods for pretreating a bipolar plate by disrupting or etching surfaces thereof, whereafter the bipolar plate may be used in a battery system. An example of a battery system, e.g., a redox flow battery system, is depicted in FIG. 1 which includes a battery cell with at least one bipolar plate. In some examples, the bipolar plate may include a resin rich layer following manufacturing, which may result in relatively high resistance along with poor plating and conductivity at the negative electrode, particularly when the battery system is a plating redox flow battery system. In order to increase plating quality, the bipolar plate may be pretreated so as to disrupt the resin rich layer to increase a surface roughness of the bipolar plate, and thereby mitigate electrochemical performance losses ascribed thereto. Accordingly, in embodiments provided herein, a battery system may include a bipolar plate that has been pretreated for activation via laser ablation such that least one resin rich layer of the bipolar plate is textured or otherwise roughened. An example of a bipolar plate assembly including at least one bipolar plate that may be pretreated by laser ablation is illustrated in FIG. 2.

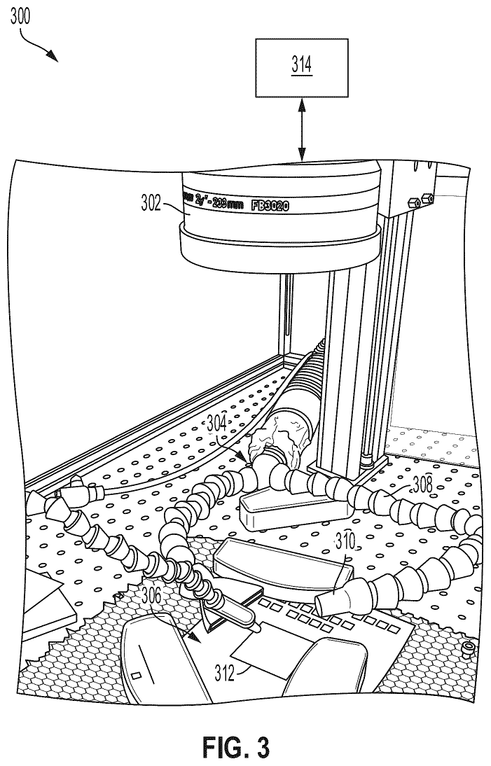

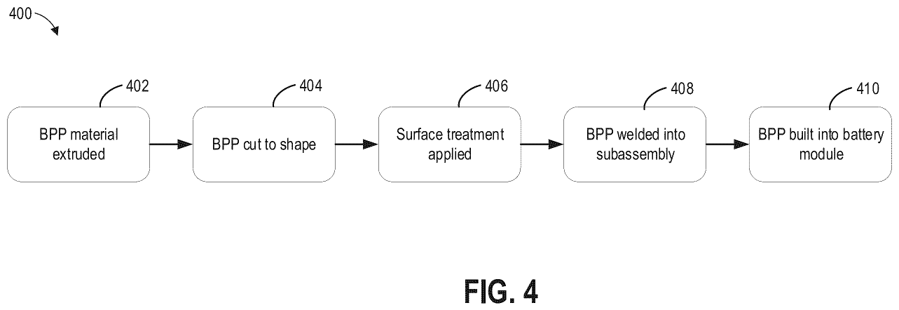

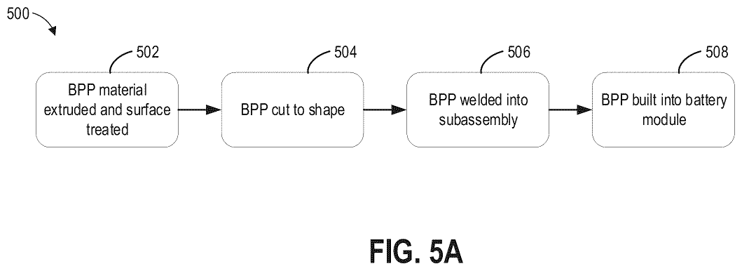

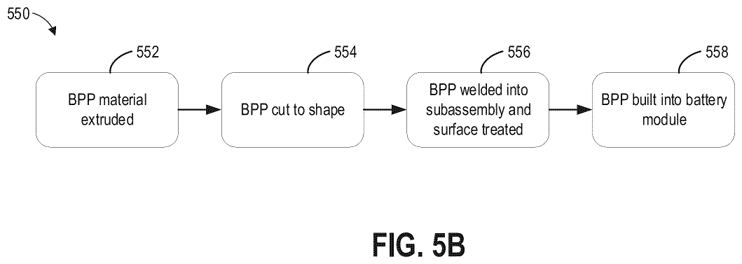

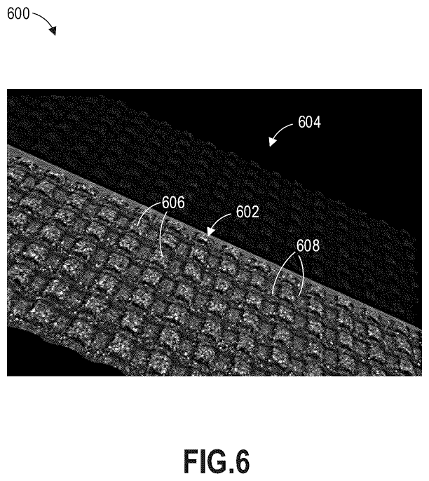

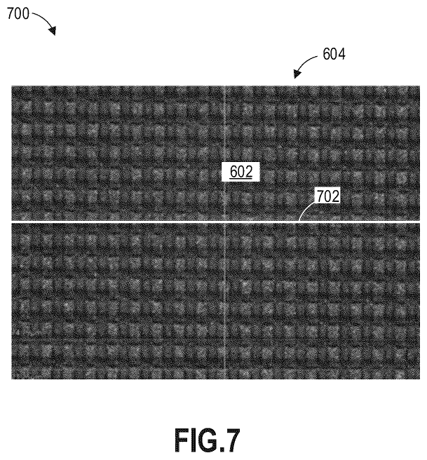

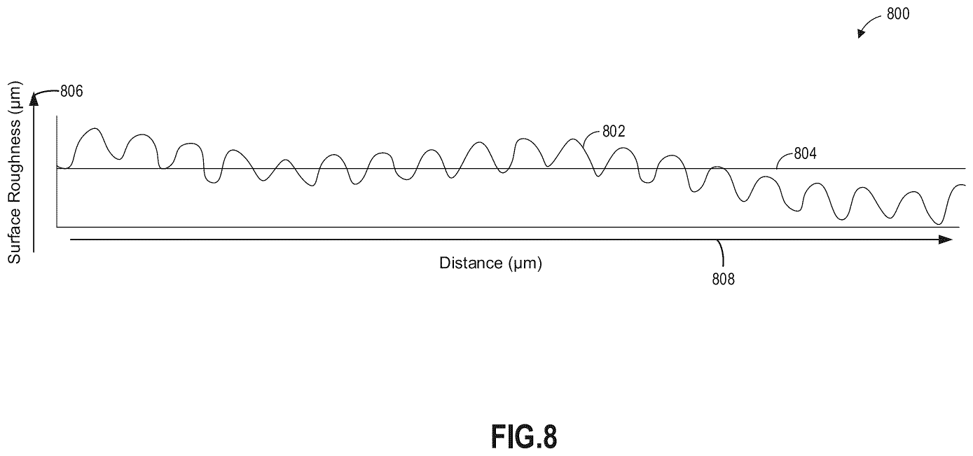

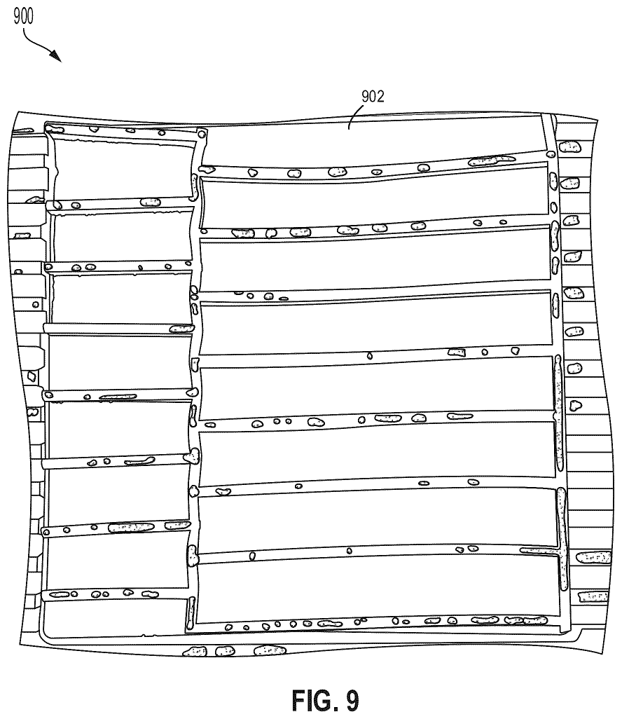

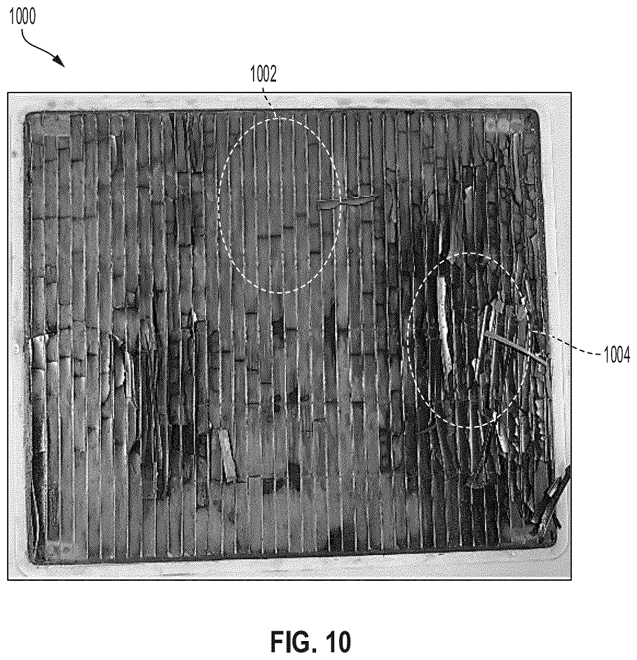

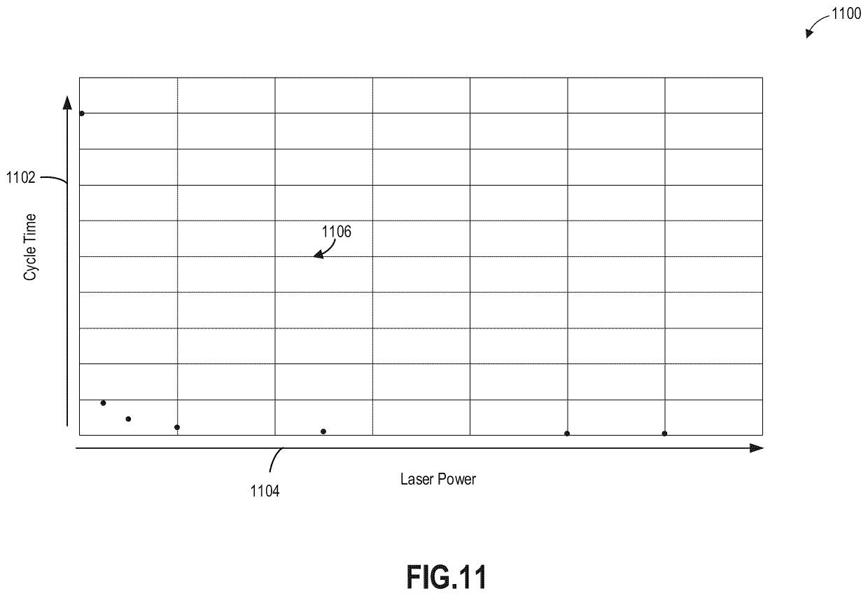

Further, an example of a laser ablation system for pretreating a bipolar plate surface is depicted in FIG. 3. Examples of manufacturing process flows for fabricating a bipolar plate for use in a battery module are shown in FIGS. 4-5B, respectively. Microscope images of a pretreated surface of an exemplary bipolar plate are shown in FIGS. 6-7 and a roughness profile obtained from a cross-section of the bipolar plate is plotted in FIG. 8. An image of a bipolar plate pretreated by laser ablation and plated with a metal is depicted in FIG. 9 and an image of a bipolar plate pretreated by a mechanical process and plated with a metal is depicted in FIG. 10. An effect of cycle time on laser power is illustrated in a graph in FIG. 11.

As described above, the bipolar plate may be incorporated in a battery system. In one example, the battery system may be a redox flow battery system 10, as shown in FIG. 1. It will be appreciated, however, that surface treatment of the bipolar plate described herein may be applied to bipolar plates for various other types of electrochemical systems. Turning now to FIG. 1, in the redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fc²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (4) and (5), wherein the forward reactions (left to right) indicate electrochemical reactions during battery charge, while the reverse reactions (right to left) indicate electrochemical reactions during battery discharge:

$$\begin{matrix}{Fe}^{2 +} + 2 {e}^{-} ↔ {Fe}^{0} & - 0.44 V & ( negative electrode )\end{matrix} \qquad ( 4 )$$

$$\begin{matrix}2 {Fe}^{2 +} ↔ 2 {Fe}^{3 +} + 2 {e}^{-} & + 0.77 V & ( positive electrode )\end{matrix} \qquad ( 5 )$$

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fc⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fc³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

In some examples, one or both of the bipolar plates 36 and 38 may be formed from a carbon-based material (such as graphite or a graphite composite material) and bound by a binder such as a resin. In one example, the bipolar plates 36, 38 may be formed of carbon and/or graphite loaded with polypropylene. For instance, the graphite composite material may be shaped into a given bipolar plate via a compression molding process or an injection molding process. As a result of the molding process, a resin rich layer may form at an outer surface of the given bipolar plate, e.g., on upper and/or lower surfaces thereof (the lower surface being opposite to the upper surface and each of the upper and lower surfaces extending in planes perpendicular to a thickness of the bipolar plate). The resin rich layer may be undesirable for electrochemical performance, the layer contributing to relatively high resistance and/or relatively low conductivity.

Further, if a resin rich layer of a bipolar plate, e.g., the first bipolar plate 36 (in the negative electrode compartment 20) is not treated, the resin rich layer may lead to non-uniform plating during charging of the redox flow battery system 10. For example, Fe⁰ plated on a pristine (e.g., untreated) bipolar plate including such a resin rich layer may crack and flake, which may block pores of the electrodes, or may be uneven, which may result in degraded membranes (e.g., the separator 24), electrical shorting due to Fe⁰ accumulation, dendrite formation over extended cycling, and low conductivity.

To mitigate such plating issues, as well as to prevent electrochemical performance losses, a continuous surface morphology of the resin rich layer may be disrupted via pretreatment during manufacturing of the redox flow battery system 10. As used herein, reference to “continuous” when describing a surface morphology indicates a substantially smooth and uninterrupted surface (“substantially” may be used herein as a qualifier meaning “effectively”). In contrast, “disrupted” when describing a surface morphology may refer to a surface having been substantially pitted, conditioned, etched, roughened, coarsened, cracked, incised, abraded, textured, or otherwise deformed (accordingly, cracking may be desirable under select conditions, such as when cracking is limited to the resin rich layer and does not result in flaking of the resin rich layer or plating thereon). Further, “pristine” when describing a given bipolar plate configuration may refer to a bipolar plate being formed (e.g., from compression or injection molding) without any subsequent treatment prior to undergoing charge cycling in a given redox flow battery system. In contrast, “pretreated” when describing a given bipolar plate configuration may refer to post-formation treatment to disrupt or otherwise condition a surface morphology of the bipolar plate for increased electrochemical performance and/or structural integrity (the post-formation treatment being performed prior to the bipolar plate undergoing charge cycling in a given redox flow battery system, hence “pretreated”).

In some examples, the pretreatment may be a mechanical pretreatment, such as abrasion, grinding, polishing, sand blasting, sand paper polishing, a timing belt, and/or other manual or automated mechanical pretreatments that scrape, scratch, or otherwise abrade one or more surfaces of a bipolar plate being pretreated. However, though such mechanical pretreatments may mitigate some electrochemical performance losses in certain cases, a precision of the mechanical pretreatments may be low. Further, a processing time of the mechanical pretreatments may be long and may demand use of consumables, which may impose increased costs.

Accordingly, embodiments are provided herein to both mitigate electrochemical performance losses and retain long-term durability by pretreating a bipolar plate via laser ablation. In an exemplary embodiment, and as described in detail below with reference to FIGS. 2-11, the bipolar plate may be pretreated by exposing at least one surface of the bipolar plate to a laser, thereby allowing a pattern to be etched into the surface. Application of laser ablation, rather than mechanical roughening techniques, may provide texturing of bipolar plates in a controlled, reproducible manner and with reduced consumption of disposable materials. As such, a target roughness, such as an Arithmetic Average Roughness (Ra) of at least 8 μm, may be achieved.

Continuing with FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together.

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82.

The controller 88 may further execute control schemes based on an operating mode of the redox flow battery system 10. For example, the controller 88 may command charge cycling of the redox flow battery cell 18 to uniformly plate the negative electrode 26. As discussed above, in one example, uniform plating of the negative electrode may be facilitated by the surface disrupted first bipolar plate 36. As another example, the controller 88 may further control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

In battery cells of a battery systems, one or more bipolar plates, such as the first and second bipolar plates 36, 38 of FIG. 1, may be included in an electrode assembly to isolate the battery cells from one another, provide electrical conductivity between the battery cells, promote flow of fluids carrying active materials, and to provide a structural support to the stacks of the battery cells. The bipolar plates may be in a bipolar plate assembly 200, as shown in an exploded view in FIG. 2. The bipolar plate assembly 200 may be arranged in a battery cell as indicated by either the first bipolar plate 36 or the second bipolar plate 38 of FIG. 1, where the bipolar plate assembly 200 may incorporate one or more bipolar plates 202.

The bipolar plate assembly 200 includes three bipolar plates 202 configured to be inserted into windows 204 of a bipolar frame plate 206. The bipolar plates 202 may have dimensions corresponding to dimensions of the windows 204 to allow the bipolar plates 202 to be coupled to edges of the windows 204 such that sealed interfaces are formed between the bipolar plates 202 and the edges of the windows 204. In other words, the bipolar plate assembly 200 may be sealed such that fluid does not flow between edges of the bipolar plates 202 and edges of the windows 204.

In one example, the bipolar plates 202 may be welded to the bipolar frame plate 206, although other techniques are possible, such as adhesive. The bipolar frame plate 206 may be formed of a polymer such as chlorinated polyvinyl chloride (CPVC), or other suitable polymers. The bipolar plate assembly 200 may also include various flow-directing structures 208, such as inlets, outlets, ports, shunt channels, distribution channels, etc. Furthermore, a configuration of the bipolar plate assembly 200 depicted in FIG. 2 is a non-limiting example of how a bipolar plate assembly may be arranged. In other examples, a bipolar plate assembly may include a single, large bipolar plate inserted into a single window that extends across an area occupied by the three windows 204 shown in FIG. 2, more or less than three bipolar plates, or the relative positions, quantities, and geometries of the windows, bipolar plates, and flow-directing structures may vary from those show in FIG. 2, without departing from the scope of the present disclosure.

As described above, at least one surface of a bipolar plate may be pretreated using laser ablation to etch the surface. By etching the surface, a roughness of the surface may be altered, which may moderate a distribution of plated metal that is deposited on the bipolar plate surface during charging of a battery system. In one example, increasing the roughness to a Ra value of at least 8 μm may increase a uniformity of a plating layer formed on the surface of the bipolar plate, which may reduce flaking, dendrite formation, and electrical shorting issues, and increase a conductivity of the bipolar plate. For example, the surface may be irradiated with a laser beam which may be directed over the surface in a targeted, controlled manner. Direct irradiation by the laser beam causes material to be removed from the surface, thereby leaving a pattern etched into the surface. A depth of material removal and the etched pattern may be predetermined, e.g., selected by a user, and implemented by a laser ablation system 300, as shown in FIG. 3.

By using laser ablation to treat the surface of the bipolar plate, rather than a mechanical process, a specific, predetermined roughness may be achieved. Further, a target roughness may be obtained consistently across the surface. In addition, etching of the surface may be selectively varied and variations in the etching may be serialized and tracked, according to location along the surface. As well, etching by laser ablation precludes formation of burrs or high points, which may degrade plating quality, and the bipolar plate may be exposed to less heat during laser ablation, compared to mechanical roughening processes, which may reduce absorption of heat at the bipolar plate. As a result, the bipolar plate may be less prone to warping and may remain more flat.

The laser ablation system 300 includes a laser process head 302, a gas assist device 304, and a sample platform 306. The laser process head 302 may house a laser light source, as well as various other components for controlling and moderating a laser beam, and translation of the laser beam, emitted from the laser light source. Although a single laser process head is shown in FIG. 3, the laser ablation system may include multiple laser process heads, in other examples. The gas assist device 304 may deliver air, nitrogen, or some other type of shielding gas that may be used to flood, e.g., cover, a surface of a sample with the gas prior to irradiating the sample with the laser beam. For example, the gas assist device 304 may include gas hoses 308 with nozzles 310 for directing gas flow to the sample surface. The sample may be a bipolar plate (or a portion thereof), which may be formed of carbon/graphite and polypropylene, in one example.

The sample platform 306 may include a sample holder 312, which may be a region of the sample holder 312 configured to hold the sample in place during laser ablation. In one example, the sample holder 312 may be an area at which a vacuum is transmitted through the sample platform 306 which may thereby maintain a position of the sample relative to the sample platform 306. In other examples, however, other mechanisms for securing the sample to the sample holder 312 may be utilized, such as clips, clamps, adhesive, etc.

To etch the surface of the sample, the sample may be coupled to the sample platform 306, under the laser process head 302, and blanketed with a layer of gas using the gas assist device 304. The laser light source may be activated and the sample may be irradiated with the laser beam. The laser process head 302 may include a motor for varying a position of the laser beam relative to the sample to etch a predetermined pattern over at least a portion of a surface of the sample. In some examples, an entire area of the surface of the sample may be etched with the predetermined pattern. In yet other examples, the sample may be larger than an area that the motorized laser is able to cover, which may demand manual adjustment of the position of sample relative to the laser beam. Furthermore, in some examples, the laser process head 302 may not include a motor to vary the relative position of the laser beam and the sample platform 306 may instead be configured with a motor to adjust a position of the sample relative to the laser beam during laser ablation of the sample.

The laser ablation system 300 may be controlled by a controller 314, which may include software and hardware for controlling operation of the laser ablation system 300. For example, the controller 314 may include a user interface by which the user may input desired parameters for etching the sample, such as an intensity of the beam and/or a target depth of etching, a pattern to be etched into the surface, dimensions of the sample, etc. The controller 314 may be configured with instructions for receiving the input from the user, as well as data from sensors of the laser ablation system 300, and activating/deactivating and moderating emission of the laser beam according to the input, data, and instructions.

To increase a manufacturing efficiency of bipolar plates (BPPs) with at least one pretreated surface, the bipolar plates may be etched either immediately after formation of the bipolar plates and prior to post-formation processing, or etched after the post-formation processing. For example, a conventional process flow 400 is shown in FIG. 4 for fabricating surface treated bipolar plates is shown FIG. 4, to which various types of pretreatments may be applied. Examples of higher efficiency process flows for fabricating surface treated bipolar plates, where the bipolar plates are treated by laser ablation, are depicted in FIGS. 5A-5B. The process flows may be at least partially automated and executed on an assembly line with various instruments and equipment for performing processing steps of the process flows. Additionally, at least some of the steps may be performed or assisted by an operator.

The conventional process flow 400 includes extruding a material of the bipolar plate at 402. For example, the material may be carbon or graphite loaded with polypropylene as a binder and extruded as a sheet. The extruded material is cut at 404 according to target dimensions for the bipolar plate, e.g., into rectangles, squares, etc., with predetermined lengths and widths. For each shape, e.g., bipolar plate, cut from the extruded material, at least one surface of the bipolar plate may be subjected to a roughening process at 406 to treat the surface of the bipolar plate. For example, the roughening process may include machine sanding, which may include relocating the bipolar plates to a different instrument for sanding, as well as removing debris from the bipolar plates and cleaning the bipolar plates before returning the bipolar plates to the assembly line. In some examples, laser ablation, as described below, may instead be applied as described below with respect to high efficiency process flows shown in FIGS. 5A and 5B which may expedite the roughening process.

The treated bipolar plate may be welded into a subassembly at 408 to form a bipolar plate assembly. As an example, the bipolar plate may be welded to a bipolar frame plate, such as the bipolar frame plate 206 of FIG. 2. The resulting subassembly, e.g., a bipolar plate assembly, may be incorporated into a battery module at 410, such as the power module 120 of FIG. 1, during manufacture and assembly of the battery module.

Alternatively, the bipolar plate may be manufactured according to a first example of a higher efficiency process flow 500 depicted at FIG. 5A. The first example of the higher efficiency process flow 500 includes extruding the bipolar polar plate material (e.g., graphite loaded with polypropylene) as a sheet and treating a surface of the extruded sheet at 502. For example, the extruded sheet may be immediately positioned in range of a laser process head along the assembly line subsequent to extrusion. The surface of the extruded sheet may be treated as the sheet is extruded by irradiating the surface of the extruded sheet with a laser beam via a system configured to effect a desired pattern, texture, and roughness at the surface via laser ablation (e.g., laser ablation system 300 of FIG. 3). For example, after exiting the extruder, the sheet may immediately pass under a laser ablation system. In alternate examples, the extruded sheet may be allowed to cool before passing under the laser ablation system. A pattern may be etched into the surface, creating, for example, a predetermined tessellation and texture at the surface. In one example, the pattern may be a grid of squares, etched to provide a desired roughness of the surface. However, in other examples, the pattern may be a tessellation of another geometric shape, such as rectangles, diamonds, triangles, etc. In some examples, the desired pattern may include a first pattern and an additional pattern. Both the first pattern and the additional pattern may be serialized over a surface of the bipolar plate. In some examples, the first pattern and the additional pattern may be overlaid. In alternate examples, the first pattern may be on a first portion of the bipolar plate and the additional pattern may be on a second portion of the bipolar plate. The desired roughness may be an average roughness (Ra) of 8 μm or greater, as an example.

After the laser ablation of the surface is achieved, the treated extruded sheet is cut according to desired bipolar plate dimensions at 504. Bipolar plates obtained by cutting the extruded sheet are welded to a bipolar frame plate to form a bipolar plate assembly at 506. At 508, the bipolar plate assembly is incorporated into a battery during manufacture and assembly of the battery module. In this way, laser ablation of individual bipolar plates is precluded. Instead, the surface treatment is applied immediately after extrusion to an entire extruded sheet, thereby reducing time and labor directed towards handing of each bipolar plate during surface treatment.

As shown in FIG. 5B, in a second example of a higher efficiency process flow for fabricating surface treated bipolar plates, the bipolar plate material may be extruded at 552 and cut according to desired bipolar plate dimensions at 554. At 556, the bipolar plates may be welded to a frame plate to form a bipolar plate assembly, where the bipolar plates may be surface treated upon welding. For example, laser ablation may be applied to the bipolar plate surface immediately before, during, or after welding, along the assembly line. Alternatively, the laser ablation may be applied immediately prior to installing the bipolar plate assembly in a battery module at 558.

The first and second examples of the higher efficiency process flows 500 and 550 may provide similar results with respect to acquiring a desired treatment of the bipolar plate surface with fewer processing steps than the conventional process flow 400 of FIG. 4. However, the first higher efficiency process flow 500 may demand equipment able to etch and manipulate sheets or plates of large dimensions. For example, the already cut bipolar plates receive the surface treatment in the second higher efficiency process flow 550 whereas the extruded bipolar plate material sheets receive the surface treatment in the first higher efficiency process flow 500, the extruded bipolar plate material sheets having larger dimensions than the cut bipolar plates.

Furthermore, a system for performing laser ablation (e.g., the laser ablation system 300 of FIG. 3), may be integrated into an assembly line for fabricating the bipolar plate. For example, for the first example of the higher efficiency process flow 500, the laser ablation system may be positioned immediately after an extruder used to extrude the bipolar plate. The system may be incorporated into the assembly line such that an extrusion rate or speed is not adversely affected. The assembly line may further include a cooling trough for cooling the bipolar plate after extrusion that may also operate as a conveyor for the laser ablation system. In addition, a capacity of the laser ablation system (e.g., surface area that can be etched per ablation cycle) may correspond linearly to a number of laser process heads included, and a power rating of the laser process heads. The laser ablation system is therefore readily scaled according to application.

For the second example of the higher efficiency process flow 550, the laser ablation system may instead be integrated into the assembly line at a welding station. For example, the assembly line may include a cooling system, such as a cooling trough, for cooling the bipolar plate assembly after the bipolar plate is welded to the frame plate. The cooling system may similarly convey the bipolar plate assembly to the laser ablation system. Whether the laser ablation system is arranged in the assembly line subsequent to extrusion or to welding, etching of the bipolar plate surface may be performed with minimal interruption to processing of the bipolar plate along the assembly line, and with reduced steps for handling relative to mechanical roughening processes.

A further benefit of bipolar plate roughening via laser ablation includes a longer mean time between system degradation due to fewer moving parts, and fewer components prone to wear, compared to mechanical techniques. Scheduled maintenance of the surface treatment system (e.g., the laser ablation system) may therefore be reduced compared to a mechanical system such as a sander, and the laser ablation system may demand less tuning of parameters at start up. For example, for the laser ablation system, tuning of fewer parameters, including focal distance, laser power, and laser speed is demanded at start up, whereas at startup of mechanical processes, tuning of belt speed, belt grit, conveyor speed, part thickness, and various other transient properties may be demanded, which may be variables that change over a duty cycle of components, such as belt life, drum heat, etc.

Laser ablation may be a faster technique for achieving surface roughening relative to any mechanical roughening process. This may be attributed to application of a single treatment step to provide etching along two directions across a plane of the bipolar plate, e.g., along a length and a width of the bipolar plate, compared to two individual treatment steps demanded for roughening along each of the directions when mechanical roughening is utilized. In addition, laser ablation may vaporize material of the bipolar plate to form the desired surface roughness, for this reason the removed material may not demand further collection after laser ablation. Other post-processing procedures may demand additional steps for removing burrs and high spots, laser ablation therefore negates challenges associated with automating removal of the burrs and high spots. While verification of surface roughness may demand use of equipment separate from the assembly line, degradation of laser ablation etching quality may occur over a prolonged period of time, such as months or years, in contrast to mechanical roughening quality, which may occur over shorter time frames, such as within a day, due to breakdown of belts, sanding pads, etc. The mechanical roughening processes may therefore demand more rigorous verification procedures than etching by laser ablation.

A pattern etched into a surface of a bipolar plate for imparting the surface with a target roughness may be a tessellation of, for example, squares, as shown in FIGS. 6, and 7, from an angled perspective 600 and a top-down view 700, respectively. Therein, microscope images of a treated surface 602 of a bipolar plate 604 is shown. For example, the bipolar plate 604 may be 72 mm wide by 72 mm long with a thickness of 0.8 mm, formed of extruded polypropylene and graphite (or carbon), and processed as described in 402 to 406 of FIG. 4 or 502 to 504 of FIG. 5A.

The treated surface 602 may be etched with a repeating pattern (e.g., tessellation) of squares 606, configured as a grid across the treated surface 602. Each of the squares 606 may be a raised structure protruding outwards from the treated surface 602 relative to valleys or grooves 608 extending between the squares 606 and across a length and a width of an imaged area of the bipolar plate 604 depicted in each of FIGS. 6 and 7. An amount of protrusion of the squares 606 relative to the grooves 608 may determine an overall roughness (e.g., Ra value) of the treated surface 602.

Etching the tessellation of squares, as shown in FIGS. 6-7, comprising etching along linear paths, may provide a pattern that demands minimal change of directions of a laser process head during an ablation cycle. By minimizing changes in direction during ablation, the laser ablation system may spend a greater portion of time operating at full speed rather than undergoing periods of deceleration and periods of acceleration. Etching may then be achieved at a faster rate. In other examples, the pattern may be circular or non-linear but may demand longer cycle times. However, the longer cycle times may be offset by benefits offered by non-linear patterns, such as preclusion of an untreated section at a center of each raised structure which may be found in linear patterns. Additionally, in some instances, etching of linear patterns may stress the bipolar plate surface in a manner that may be propagated to plated layers on the bipolar plate surface, increasing a likelihood of cracking relative to non-linear patterns.

For example, a cross-section of the bipolar plate 604 may be obtained along line 702 of FIG. 7. A roughness profile 802 of the cross-section is shown in a graph 800 in FIG. 8, plotting a roughness value (in microns, μm) along the y-axis and a distance across the bipolar plate along the axis (also in μm) along the x-axis. An arrow 806 indicates a direction of increasing roughness along the y-axis and an arrow 808 indicates a direction of increasing distance along the x-axis. The roughness profile 802 depicts a surface contour of the bipolar plate 604, e.g., along the treated surface 602, which includes peaks separated by valleys. Heights of the peaks and depths of the valleys may be relatively uniform along the surface. A spacing between peaks and depths of the valleys may be selected to optimize electrolyte flow for achieving desirable plating quality, which cannot be adjusted analogously when mechanical roughening processes are applied. The surface contour may be sinuous, having only curved contours and no sharp edges. A uniformity of the surface contour may promote robust plating. The roughness value is provided relative to a baseline depth of 0 (as indicated by line 804) and may be a positive value (e.g., corresponding to the squares 606 of FIGS. 6 and 7) or a negative value (e.g., corresponding to the grooves 608 of FIGS. 6 and 7). An average of all measured values of the roughness for the roughness profile 802 may be reported as a Ra. For the bipolar plate 604 of FIGS. 6-7, the Ra is 9.3 μm.

In one example, a Ra value of at least 8 μm may provide a sufficient roughness of a surface to promote plating at the bipolar plate that is uniform and resistant to flaking. For example, an image of a bipolar plate 900 with a surface treated by laser ablation as described herein in shown in FIG. 9. The surface of the bipolar plate 900 has a Ra value of at least 8 μm across the entire surface and is plated with a metal layer 902 after undergoing a charge cycle of a battery system. The metal layer 902 is formed over the treated surface of the bipolar plate 900 and is smooth, continuous, and homogeneous. Additionally, metal layer 902 does not include cracks and is not flaking off of bipolar plate 900.

In contrast, as shown in FIG. 10, an image of a bipolar plate 1000 having a surface treated by a mechanical technique, such as sanding, is depicted. The surface of the bipolar plate 1000 is plated with a metal after undergoing a charge cycle of a battery system. A roughness of the bipolar plate surface is variable, having regions of high Ra value, including a first region 1002, and regions of low Ra value, including a second region 1004. The high Ra value regions correspond to Ra values of 8 μm or greater while the regions of low Ra value correspond to Ra values of less than 8.

As shown in FIG. 1000, the plated metal at the first region 1002 is smoother and more homogeneous than the plated metal at the second region 1004. At the low Ra regions, the plated metal is flaking off of the surface of the bipolar plate 1000. The bipolar plate 1000, when treated via mechanical techniques, may demonstrate variable roughness across its surface, resulting in uneven plating as well as loss of plating in some areas.

Laser ablation parameters, such as cycle time, may be optimized via experimental testing using bipolar plate samples, such as the bipolar plates shown in FIGS. 6-7 and 9-10. Optimization of the laser ablation parameters may affect a scalability of a laser ablation system. For example, a graph 1100 is depicted in FIG. 11 showing a relationship of laser ablation cycle time, in seconds, relative to laser power, in Watts. An arrow 1102 indicates a direction of increasing cycle time along the y-axis of graph 1100 and an arrow 1104 indicates a direction of increasing laser power along the x-axis of graph 1100. Graph 1100 shows data points 1106. Each data point indicates a cycle time for treating a bipolar plate and a corresponding laser power. As laser power increases, cycle time decreases. As such, multiple lower power laser process heads (e.g., such as the laser process head 302 of FIG. 3) or a singular, higher power singular laser process heads may be utilized in the laser ablation system to provide high laser power.

For example, a higher power laser process head may ablate a spot faster than a lower power laser process head on the same material due to an increase in energy used by the higher power laser process head to remove material from the spot. The greater energy input decreases an amount of time for heating and vaporize the material. As indicated in graph 1100, by increasing power used during laser ablation (e.g., by using the higher power laser process head), a duration of an ablation cycle may be reduced for a given sample. The duration of the ablation cycle may also be decreased due to a faster ability of the higher power laser process head to travel from spot to spot.

However, while using an array of lower power laser process heads may demand an amount of power proportional to a number of the lower power laser process heads, an area treated during a given ablation cycle may increase linearly with power. Less time therefore is needed to treat a given area. Results depicted in graph 1100 depict a diminishing return on power consumed by laser ablation system relative to the ablation cycle time. Thus, a balance between power cost and ablation cycle time may be included when selecting the laser ablation system used, e.g., the array of lower laser process heads or the single higher power laser process head and when increasing/decreasing a size of the laser ablation system and associated ablation rate. Although the higher laser process head may include fewer parts and controls, its associated costs may be higher than the array of lower laser process heads. For example, when a larger surface area is to be ablated, increasing the number of laser process heads may be cost effective until a threshold amount, and then increasing the power of the laser process heads may become more desirable to maintain a target cost to speed balance.

In this way, the technical effect of pretreating a bipolar plate using laser ablation is that loss of charge capacity due to flaking of plated metal at a bipolar plate may be reduced. A plating surface of the bipolar plate may be pretreated, e.g., prior to installation of the bipolar plate into a battery system, by employing laser ablation to roughen and texturize the plating surface. The pretreatment may be applied before or after processing steps during manufacturing of the bipolar plate, such as before or after cutting an extruded material of the bipolar plate. The plating surface may be treated to have a Ra value of at least 8 μm in a uniform manner across the plating surface, to achieve homogenous, and robust plating at the bipolar plate. The pretreatment described herein may be efficient with low costs, while demonstrating high reproducibility.

The disclosure also provides support for a method for pretreatment of a bipolar plate, the method comprising: extruding a material of the bipolar plate, irradiating a surface of the bipolar plate with a laser beam to etch a pattern into the surface, and assembling the bipolar plate into a power module of a battery system. In a first example of the method, extruding the material of the bipolar plate includes extruding carbon and/or graphite loaded with polypropylene. In a second example of the method, optionally including the first example, irradiating the surface of the bipolar plate includes positioning the bipolar plate under at least one laser process head, and wherein the at least one laser process head is arranged in an assembly line for fabricating the bipolar plate, after an extruder for performing the extruding. In a third example of the method, optionally including one or both of the first and second examples, the bipolar plate is held in place under the at least one laser process head by one or more of clips, clamps, adhesive, and vacuum, and the surface of the bipolar plate is blanketed with air or gas delivered by a gas assist device prior to irradiating the surface of the bipolar plate. In a fourth example of the method, optionally including one or more or each of the first through third examples, the bipolar plate is delivered to the at least one laser process head from a cooling trough for cooling the bipolar plate after extrusion. In a fifth example of the method, optionally including one or more or each of the first through fourth examples, the material of the bipolar plate is cut according to target dimensions of the bipolar plate after irradiating the surface of the bipolar plate. In a sixth example of the method, optionally including one or more or each of the first through fifth examples, the material of the bipolar plate is cut according to target dimensions of the bipolar plate before irradiating the surface of the bipolar plate. In a seventh example of the method, optionally including one or more or each of the first through sixth examples, the pattern is etched into the surface of the bipolar plate to increase a roughness of the bipolar plate. In a eighth example of the method, optionally including one or more or each of the first through seventh examples, the roughness of the bipolar plate has an Arithmetic Average Roughness (Ra) of at least 8 μm.

The disclosure also provides support for a bipolar plate assembly for a battery system, comprising: at least one bipolar plate coupled to a frame plate, the at least one bipolar plate having a surface treated by etching a pattern into the surface using laser ablation, wherein the laser ablation is performed in an assembly line after extrusion of the at least one bipolar plate. In a first example of the system, the pattern is a tessellation of squares. In a second example of the system, optionally including the first example, the pattern is linear or non-linear. In a third example of the system, optionally including one or both of the first and second examples, a profile of the surface with the pattern includes peaks separated by valleys, and wherein a height of the peaks and a depth of the valleys is uniform across the surface. In a fourth example of the system, optionally including one or more or each of the first through third examples, the profile of the surface is sinuous and without sharp edges.

The disclosure also provides support for a method for manufacturing a bipolar plate assembly for a battery system, comprising: extruding a sheet of a bipolar plate, forming the bipolar plate assembly from the extruded sheet and a frame plate, the extruded sheet having a first pattern etched into a surface of the extruded sheet by laser ablation, and installing the bipolar plate assembly in a battery cell of the battery system. In a first example of the method, the first pattern is etched into the surface of the extruded sheet during extrusion of the extruded sheet. In a second example of the method, optionally including the first example, the extruded sheet is cut into target dimensions of the bipolar plate after the surface of the extruded sheet is etched. In a third example of the method, optionally including one or both of the first and second examples, the first pattern is etched into the surface of the extruded sheet during formation of the bipolar plate assembly. In a fourth example of the method, optionally including one or more or each of the first through third examples, the extruded sheet is cut into target dimensions of the bipolar plate before the surface of the extruded sheet is etched. In a fifth example of the method, optionally including one or more or each of the first through fourth examples, additional patterns are etched into the surface, in addition to the first pattern, and wherein the first pattern and the additional patterns are serialized and tracked.

FIGS. 2-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2-3 are drawn approximately to scale, although other dimensions or relative dimensions may be used.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for pretreatment of a bipolar plate, the method comprising:
extruding a material of the bipolar plate;
irradiating a surface of the bipolar plate with a laser beam to etch a pattern into the surface; and
assembling the bipolar plate into a power module of a battery system.

2. The method of claim 1, wherein extruding the material of the bipolar plate includes extruding carbon and/or graphite loaded with polypropylene.

3. The method of claim 1, wherein irradiating the surface of the bipolar plate includes positioning the bipolar plate under at least one laser process head, and wherein the at least one laser process head is arranged in an assembly line for fabricating the bipolar plate, after an extruder for performing the extruding.

4. The method of claim 3, wherein the bipolar plate is held in place under the at least one laser process head by one or more of clips, clamps, adhesive, and vacuum, and the surface of the bipolar plate is blanketed with air or gas delivered by a gas assist device prior to irradiating the surface of the bipolar plate.

5. The method of claim 3, wherein the bipolar plate is delivered to the at least one laser process head from a cooling trough for cooling the bipolar plate after extrusion.

6. The method of claim 1, wherein the material of the bipolar plate is cut according to target dimensions of the bipolar plate after irradiating the surface of the bipolar plate.

7. The method of claim 1, wherein the material of the bipolar plate is cut according to target dimensions of the bipolar plate before irradiating the surface of the bipolar plate.

8. The method of claim 1, wherein the pattern is etched into the surface of the bipolar plate to increase a roughness of the bipolar plate.

9. The method of claim 8, wherein the roughness of the bipolar plate has an Arithmetic Average Roughness (Ra) of at least 8 μm.

10. A bipolar plate assembly for a battery system, comprising:
at least one bipolar plate coupled to a frame plate, the at least one bipolar plate having a surface treated by etching a pattern into the surface using laser ablation, wherein the laser ablation is performed in an assembly line after extrusion of the at least one bipolar plate.

11. The bipolar plate assembly of claim 10, wherein the pattern is a tessellation of squares.

12. The bipolar plate assembly of claim 10, wherein the pattern is linear or non-linear.

13. The bipolar plate assembly of claim 10, wherein a profile of the surface with the pattern includes peaks separated by valleys, and wherein a height of the peaks and a depth of the valleys is uniform across the surface.

14. The bipolar plate assembly of claim 13, wherein the profile of the surface is sinuous and without sharp edges.

15. A method for manufacturing a bipolar plate assembly for a battery system, comprising:
extruding a sheet of a bipolar plate;
forming the bipolar plate assembly from the extruded sheet and a frame plate, the extruded sheet having a first pattern etched into a surface of the extruded sheet by laser ablation; and
installing the bipolar plate assembly in a battery cell of the battery system.

16. The method of claim 15, wherein the first pattern is etched into the surface of the extruded sheet during extrusion of the extruded sheet.

17. The method of claim 16, wherein the extruded sheet is cut into target dimensions of the bipolar plate after the surface of the extruded sheet is etched.

18. The method of claim 15, wherein the first pattern is etched into the surface of the extruded sheet during formation of the bipolar plate assembly.

19. The method of claim 18, wherein the extruded sheet is cut into target dimensions of the bipolar plate before the surface of the extruded sheet is etched.

20. The method of claim 15, wherein additional patterns are etched into the surface, in addition to the first pattern, and wherein the first pattern and the additional patterns are serialized and tracked.
